(19) United States
(12) Patent Application Publication
(10) Pub. No.: US 2016/0342553 A1
(43) Pub. Date: Nov. 24, 2016

(54) INITIATOR INJECTION FOR DIAGNOSTIC INFORMATION

(71) Applicant: HEWLETT PACKARD ENTERPRISE DEVELOPMENT LP, Houston, TX (US)

(72) Inventors: Charles R. Hanna, Houston, TX (US); Henry F. Lada, Houston, TX (US); Martin R. Rogoff, Houston, TX (US)

(21) Appl. No.: 15/114,484

(22) PCT Filed: Jan. 29, 2014
(86) PCT No.: PCT/US2014/013659

§ 371 Date: Jul. 27, 2016

(51) Int. Cl. G06F 13/40; G06F 13/42

(52) U.S. Cl. CPC G06F 13/4081; G06F 13/4282

(57) ABSTRACT

Configuring an expander device of a storage cartridge. The expander device may be configured to partition a time slice of a serially attached small computer system protocol data stream. A request for diagnostic information of components of the storage cartridge is received from a chassis manager. A SATA initiator is injected in a time slice in a response by the expander device to receiving the request from the chassis manager.

### BACKGROUND

Serial advanced technology attachment (SATA) is a standard computer bus interface used to connect host bus adapters to storage devices and other drives. Serial attached small computer system interface (SAS) is a communication protocol for enabling communication between computing devices. An advantage of SAS is interoperability with SATA storage drives. SAS devices include initiators, targets, and expanders. Initiators are devices that can initiate SAS requests, and targets are storage devices that receive and process the SAS requests from initiators. Expander devices are devices that can facilitate connections between multiple targets and a single initiator. The SAS protocol utilizes a point-to-point bus topology; therefore, each target is connected by a dedicated link to an initiator unless an expander is used.

### BRIEF DESCRIPTION OF THE DRAWINGS

Various features and advantages of the invention will become apparent from the following description of embodiments of the invention, given by way of example only, which is made with reference to the accompanying drawings, of which:

FIG. 1 is a schematic diagram of an example system for providing a chassis manager access to a storage device;

FIG. 2 is a block diagram of the expander device having logic for injecting a pseudo SATA initiator;

FIG. 3 is a diagram of an example pseudo SATA initiator that is injected into a storage drive in accordance with time-domain slicing;

FIG. 4 is a flowchart of an example method for execution by an expander device providing SATA initiator time sharing of storage device slices, and injection of a health request initiated by a chassis manager;

FIG. 5 is a flowchart of an example method for execution by an expander that receives a health request from chassis manager and obtains diagnostics information from a SATA storage device; and

FIG. 6 is a block diagram showing an example non-transitory, computer-readable medium that stores instructions for providing SATA initiator addressing, storage device slicing, and injecting a health request.

### DETAILED DESCRIPTION

The techniques discussed herein generally relate to providing a method and system for requesting diagnostic information from a SATA device such as a SATA storage cartridge, or a SATA storage drive. SATA devices traditionally have no notion of multiple SATA hosts. Typically, a host processor is configured to communicate with a SATA device through a SATA host controller, which receives commands from the host processor that are then sent to the SATA device. However, an expander of a storage cartridge may be used to perform time division multiple access (TDMA) slicing of the SATA data stream. When multiple server nodes share a single SATA storage device (e.g., HDD, SSD or flash device), in terms of time-access and/or capacity in a SATA-only domain, it can be problematic to have each server report storage device health and temperature information to a central location. In one example, disclosed is an expander communicatively coupled to a chassis manager, wherein a SATA initiator is injected in a time slice of the SATA data stream such that diagnostic information may be requested from the SATA storage cartridge even when a SATA controller is unavailable.

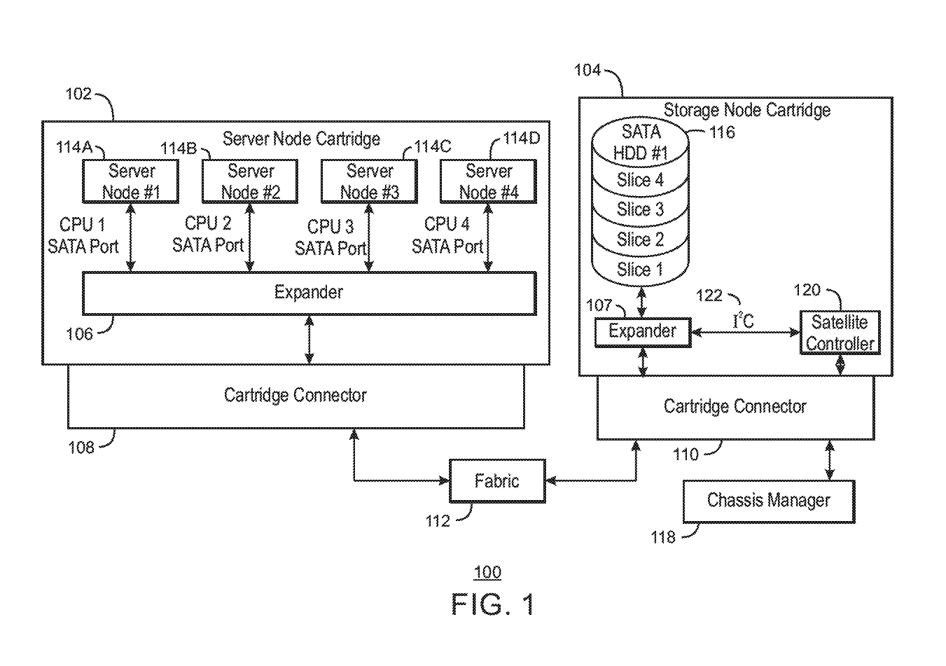

FIG. 1 is a schematic diagram of an example system for providing a chassis manager access to a storage device. System 100 includes server node cartridge 102 and storage node cartridge 104. The system 100 may be a modular system such as a rack server system or a blade server system, wherein server node cartridge 102 and storage node cartridge 104 can be easily removed from, or installed in, the system 100. Server node cartridge 102 may be a modular unit that provides processing for the system 100, and storage cartridge 104 may be a modular unit that provides storage for the system 100.

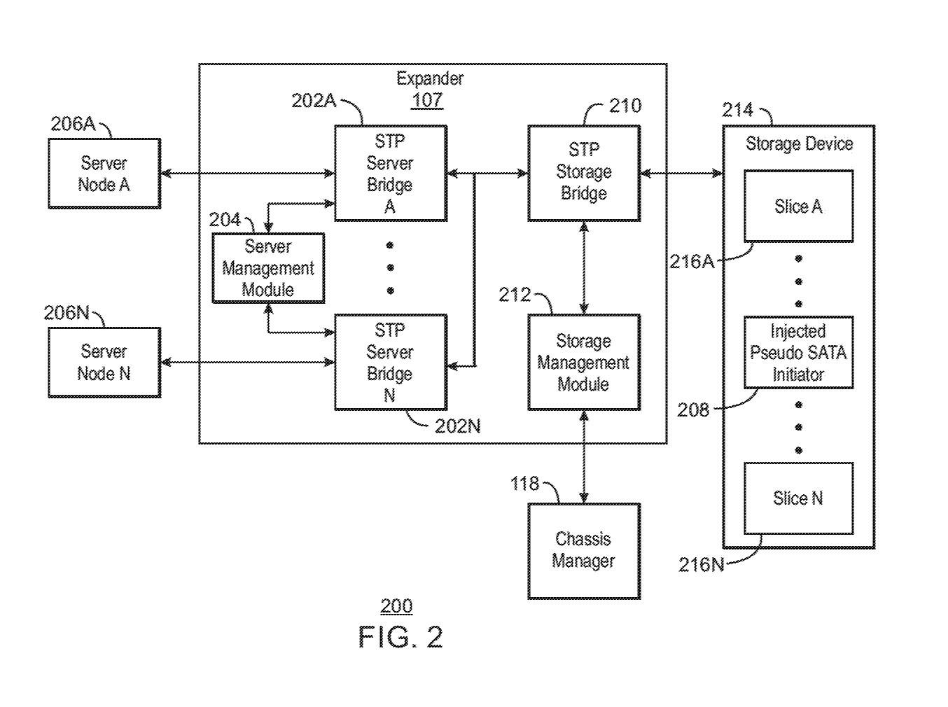

Each of the server node cartridge 102 and the storage node cartridge 104 has an expander 106 and 107, respectively, which can be connected between cartridge connectors 108 and 110 via fabric 112. The expander 106 at the server cartridge unit 102 includes STP server bridges (not shown) that are configured to provide a bridging function between associated server nodes 114A, 114B, 114C, 114D, etc., and a STP storage bridge via fabric 112, as discussed in more detail below in regard to FIG. 2. The expanders 106 and 107, thereby facilitate communication between the server nodes of the server node cartridge 102, such as server nodes 114A, 114B, 114C, 114D, and the storage device 116. Each of the STP server bridges may be configured by a server management module (not shown) to assign a SAS address to and associate a target address of the STP storage bridge with each of the server nodes 114A, 114B, 114C, 114D, etc. Once configured, the STP server may inject the associated SAS address into SATA protocol received from a respective server node (e.g., server node 114A, 114B, 114C, 114D, etc.) before passing a SATA protocol data stream to the STP storage bridge at the target address.

The expander 107 at the storage node cartridge 104 may be configured to communicate with the expander 106 of the server node cartridge 102 in response to an STP connection request. The expander 107 may process SATA requests from the server nodes 114A, 114B, 114C, 114D. The STP storage bridge may process a SATA request by, for example, offsetting a logical block addressing (LBA) address in the SATA request based on an included SAS address that is assigned to the originating server node (e.g., server node 114A, 114B, 114C, 114D, etc.). After offsetting the LBA address, the expander 107 may pass the SATA request to storage device 116 with the offset LBA address. The expander 107 may be configured to process a SATA request and inject an initiator based on time slicing within a SATA-only domain using a channel access method, such as time division multiple access (TDMA), wherein the SATA data stream is shared by multiple nodes, such as the server nodes 114A, 114B, 114C, 114D. In the embodiments described herein, a channel access method may be used to inject an initiator in response to a diagnostic request from a chassis manager 118.

The chassis manager 118 is configured to communicate with the expander 107 at the storage node cartridge 104 through, for example, an Ethernet connection. In some embodiments, a satellite controller 120 acts as a conduit and connection between the expander 106 and the chassis manager 118. The satellite controller 120 can be directly coupled to the expander 107 via an I²C bus 122, for example. The chassis manager 118 can be configured to send commands to the expander 107, requesting diagnostic information, such as health and temperature information related to the storage drive 116. The expander 107 can take the commands over the I²C bus 122, and inject a pseudo SATA initiator. A pseudo initiator, as referred to herein, is an initiator injected as a result of a diagnostic request rather than an initiator originating from one of the server nodes 114A, 114B, 114C, 114D. The expander 107 is configured to transfer the information from the storage drive 116 to the chassis manager, and this can be done, for example, by using the satellite controller 120 and through the I²C bus 122. The chassis manager 118 can utilize the data it receives in response to the pseudo initiator being injected to inform other controls systems. Thus, using the techniques described herein, the power, temperature and fan speed of a storage drive 116 can be more efficiently monitored and controlled, and other diagnostic information related to the storage drive 116 can be effectively provided in a SATA-only domain.

In embodiments, the chassis manager 118 is provided access to a storage device 116, independent of the server nodes 114A, 114B, 114C, 114D, etc. The chassis manager 118 sends a request for diagnostics information to the expander 107 at the storage node cartridge 104, and the expander 107 generates and injects a SATA initiator. In one example, an injection can be made by the expander 107 without the benefit of a SATA host controller that may be otherwise used. The request for drive health and other diagnostics information to the storage device 116 is the pseudo SATA initiator injected by the expander 107.

Fabric 112 provides communication paths that can comprise any means of providing communication between server node cartridge 102 and storage cartridge 104 over fabric 112. For example, physical layers (PHYs) may be part of input/output modules of ports of expander 107 and may include transmitters and receivers for communicating with transmitters and receivers of PHYs of expander 107. In fabric 112, PHYs represent physical communication structures that can be grouped as ports, which represent logical communication structures. The communication links can include communication medium which can comprise any physical means of providing electrical or optical communication such as, for example, fiber optic cable, copper cable, a suitable combination thereof and the like.

Fabric 112 is described as part of a data storage fabric such as SAS fabric architecture; however, other architectures such as Storage Area Networks (SAN) or Direct Attached Networks (DAN) may also be applicable. Storage device 116 is shown as being connected to expander 107, but storage device 116 can include a different number and configuration of expanders than shown in FIG. 1. Fabric 112 may include devices that have additional expanders which may include PHYs as part of ports of expanders. The PHYs can provide physical communication and may include transmitters and receivers to allow communication with other PHYs of other devices coupled to fabric 112. The PHYs represent physical communication elements and can be grouped or organized as ports which may represent logical communication elements.

The schematic of FIG. 1 is not intended to indicate that the system 100 is to include all of the components shown in FIG. 1. Further, any number of additional components may be included within the system 100, depending on the details of the specific implementation.

FIG. 2 is a block diagram of the expander device having logic for injecting a pseudo SATA initiator. The expander device 107 includes serial tunneling protocol (STP) server bridges (e.g., STP server bridge A 202A, STP server bridge N 202N, etc.), server management module 204, server nodes 206A, 206N, etc. that communicate with the STP server bridges 202A, 202N, a STP storage bridge 210 configured to inject a pseudo SATA initiator 208 in a drive slice of a storage device 214, and storage management module 212 configured to communicate with the chassis manager 118.

STP server bridges (e.g., STP server bridge A 202A, STP server bridge N 202N, etc.) are configured to provide a bridging function between associated server nodes (e.g., server node A 206A, server node N 206N, etc.) and STP storage bridge 210, thereby facilitating communication with storage device 214. Each of the STP server bridges (e.g., STP server bridge A 202A, STP server bridge N 202N, etc.) may be configured by server management module 204 to assign a SAS address to and associate a target address of STP storage bridge 210 with each of the server nodes (e.g., server node A 206A, server node N 206N, etc.). Once configured, the STP server bridges (e.g., STP server bridge A 202A, STP server bridge N 202N, etc.) may inject the SAS address into SATA protocol received from their respective server node (e.g., server node A 206A, server node N 206N, etc.) before passing the SATA protocol to the STP storage bridge 210 at the target address.

Each of the server nodes (e.g., server node A 206A, server node N 206N, etc.) may include a processor with one or more central processing units (CPUs) and/or cores as well as associated memory. The server nodes (e.g., server node A 206A, server node N 206N, etc.) may execute instructions for expander device 107 to provide various computing functions (e.g., provide web services, process data, etc.). In this example, the server nodes (e.g., server node A 206A, server node N 206N, etc.) may share and use storage device 214 for long-term storage.

STP storage bridge 210 provides a bridging function between storage device 214 and the STP server bridges (e.g., STP server bridge A 202A, STP server bridge N 202N, etc.). Specifically, STP storage bridge 210 may be configured to connect to an STP server bridge (e.g., STP server bridge A 204A, STP server bridge N 204N, etc.) in response to an STP connection request and then process SATA requests from the server nodes (e.g., server node A 206A, server node N 206N, etc.). This includes processing and injecting a pseudo SATA initiator 208 in the form of a request for diagnostics information, for example. STP storage bridge 210 may process an SATA request by offsetting an LBA address in the SATA request based on an included SAS address that is assigned to the initiating server node (e.g., server node A 206A, server node N 206N, etc.). After offsetting the LBA address, STP storage bridge 210 may pass the SATA request to the storage device 214 with the offset LBA address.

STP storage bridge 210 may also be configured to partition storage device 214 into drive slices (e.g., slice A 216A, slice N 216N, etc.) as specified by storage management module 212. For example, storage management module 212 may specify a quantity of drive slices and a size for each drive slice, where each drive slice is assigned to a corresponding server node (e.g., server node A 206A, server node N 206N, etc.). A drive slice (e.g., slice A 216A, slice N 216N, etc.) of storage device 214 may be a logical storage unit. For example, a drive slice (e.g., slice A 216A, slice N 216N, etc.) may be a range of storage cylinders of a hard drive that are reserved for use by a corresponding server node (e.g., server node A 206A, server node N 206N, etc.).

STP storage bridge 210 may inject a pseudo SATA initiator 208 configured to facilitate communications between the chassis manager 118 of FIG. 1. The chassis manager 118 communicates with the expander device 107, and the expander device 107 is configured to inject what appears to the system to be a SATA initiator, but what is better described as a pseudo SATA initiator. As discussed above, a pseudo initiator, is an initiator injected as a result of a diagnostic request from the chassis manager 118, rather than an SATA controller initiator originating from one of the server nodes 114A, 114B, 114C, 114D. The pseudo SATA initiator is injected as a result of firmware executing within the expander device 107, as opposed to hardware components associated with server nodes. The injected pseudo SATA initiator 208 can be a request for diagnostics that is initiated by the chassis manager 118. The request for diagnostics can be injected into, for example, a time slice of a target drive in much the same way as an ordinary SATA initiator.

In some embodiments, the storage management module 212 may configure STP storage bridge 210 with operating parameters, which, in some embodiments, can be received from the chassis manager 118. Specifically, storage management module 212 may define a lookup table for STP storage bridge 210, wherein each record in the lookup table includes a SAS address to identify an initiator (i.e., a record for each SAS address assigned to an initiator by an initiator management module (not shown)) that is associated with a drive slice 216 of a storage device 214 connected to STP storage bridge 210. The initiator may be associated with the drive slice by an offset value that is included in each record of the lookup table, where the offset value corresponds to the starting address of the drive slice in the storage device 214. The lookup table allows the STP storage bridge 210 to process SATA requests received from the STP initiator bridges (not shown) by, for example, offsetting LBA addresses in the SATA requests based on an offset value from a relevant record in the lookup table, where the offset LBA address is directed at the drive slice associated with the initiator. At this stage, the storage device 214 may then fulfill the SATA request using the offset LBA address.

Storage device 214 may be any hardware storage device for maintaining data accessible to the server nodes (e.g., server node A 206A, server node N 206N, etc.). For example, storage device 214 may include one or more hard disk drives, solid state drives, tape drives, and/or any other suitable storage devices.

As discussed, in some embodiments the storage management module 212 may also provide a drive slice configuration to the STP storage bridge 210, which then uses the drive slice configuration to partition the storage device into drive slices for the initiators. The drive slice configuration may include, for example, parameters such as a quantity of drive slices, a size of each drive slice, a time share for an initiator assigned to each drive slice, etc. The time share of an initiator may be the portion of time allotted to fulfill SATA requests from the initiator. In an example, multiple initiators (including the pseudo SATA initiator 208 in the form of a diagnostics request initiated at the expander device 107) are sharing access to the same storage device 214, and the STP storage bridge 210 may schedule access for each of the initiators using a scheduling algorithm that accounts for the time share of each initiator.

In some cases, the management modules (e.g., initiator management module (not shown), storage management module 212) may include interfaces to allow users, such as system administrators of expander device 107, to specify or modify operating parameters. The interfaces may allow the system administrator to access the operating parameters using an electronic device, such as a personal computer, with a user interface for configuring the management modules. For example, an interface may allow a system administrator to specify the SAS address and target address that should be assigned to each initiator at a corresponding initiator bridge by the initiator management module. In another example, an interface may allow a system administrator to specify drive slice parameters, time share parameters for each initiator, and an initiator lookup table that should be assigned to STP storage bridge 210 by storage management module 212.

Each of the modules described above may be implemented to be executed on a processor with one or more central processing units (CPUs), microprocessors, and/or other hardware devices suitable for retrieval and execution of instructions stored in a machine-readable storage medium. As an alternative or in addition to retrieving and executing instructions, the processor may include one or more electronic circuits comprising a number of electronic components for performing the functionality of one or more of the instructions.

The machine-readable storage medium may be any electronic, magnetic, optical, or other physical storage device that stores executable instructions. Thus, the machine-readable storage medium may be, for example, Random Access Memory (RAM), an Electrically-Erasable Programmable Read-Only Memory (EEPROM), a storage drive, an optical disc, and the like.

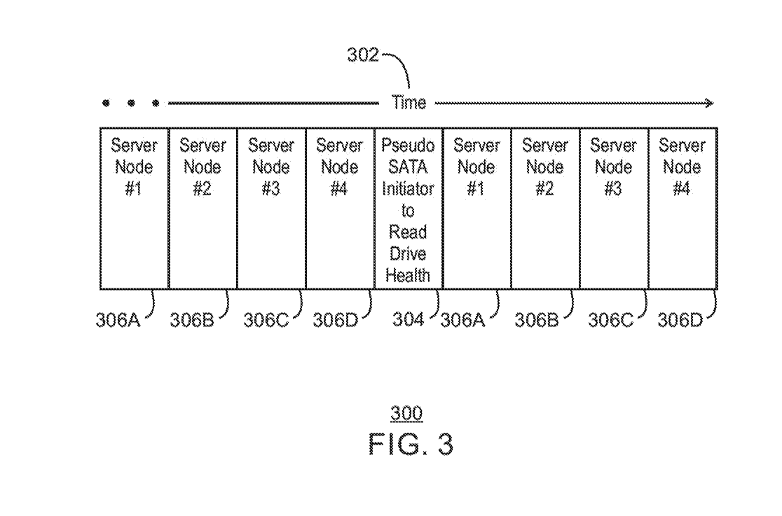

FIG. 3 is a diagram of an example pseudo SATA initiator that is injected into a storage drive in accordance with time-domain slicing. The system 300 includes a time domain 302 which is used to partition a SATA storage device (such as storage drive 116 of FIG. 2) by time slicing. A method of time slicing may include, for example, TDMA, which provides channel access based on a predetermined time frame for shared medium networks. The pseudo SATA initiator 304 is injected by an expander such as expander device 107 of FIG. 1 and FIG. 2, after the expander receives a communication request from an external chassis manager, such as chassis manager 118 of FIG. 1 and FIG. 2. The communication request can include a request for diagnostics (such as a health request, or a request for drive temperature or fan speed), and the request for diagnostics can be thought of as what is injected by the expander 107, and is recognized by the system 300 as a type of SATA initiator, a “pseudo” SATA initiator. Server nodes 306A, 306B, 3060, 306D, etc. are also allotted a slice of the time domain to gain access a storage device. In embodiments, the server nodes, such as server nodes 306A, 306B, 3060, 306D, originate from initiators of server expanders, such as the expander 106 of FIG. 1 discussed above. The server nodes 306A, 306B, 3060, 306D incorporate SATA controllers having physical initiator hardware. In contrast, the pseudo SATA initiator 304 originates as a result of a chassis manager request provided to the expander device 107 on the storage cartridge.

The schematic of FIG. 3 is not intended to indicate that the system 300 is to include all of the components shown in FIG. 3. Further, any number of additional components may be included within the system 300, depending on the details of the specific implementation.

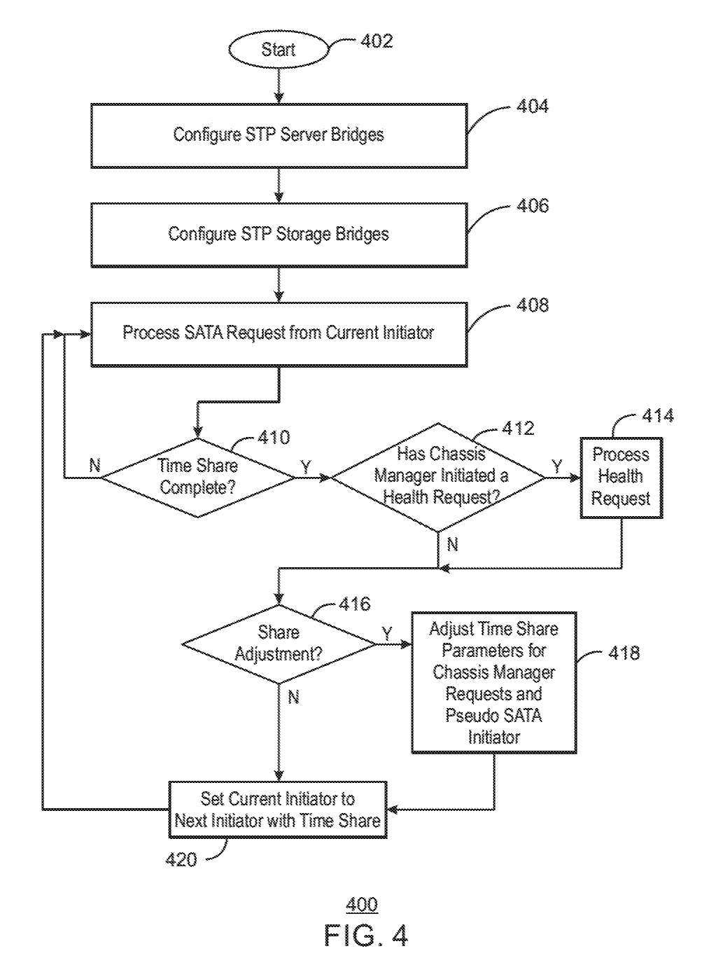

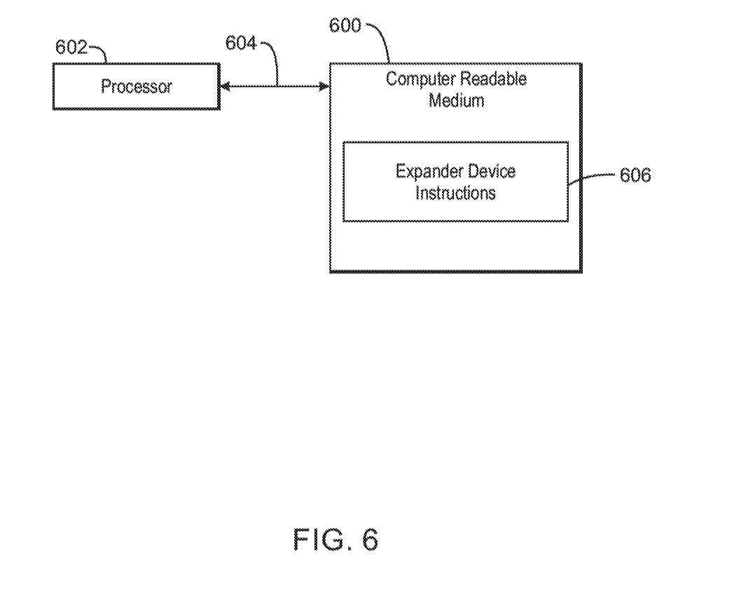

FIG. 4 is a flowchart of an example method for execution by an expander device providing SATA initiator time sharing of storage device slices, and injection of a health request initiated by a chassis manager. Although execution of method 400 is described below with reference to expander device 107 of FIG. 1 and FIG. 2, other suitable devices for execution of method 400 may be used, such as expander 106 of FIG. 1. Like numbered items are described in the same manner as done previously herein. Method 400 may be implemented in the form of executable instructions stored on a machine-readable storage medium, such as computer readable medium 600 of FIG. 6, and/or in the form of electronic circuitry.

Method 400 may start in block 402 and continue to block 404, where expander device 107 may configure an STP initiator bridge 202 with SAS and target addresses. Specifically, a SAS address may be assigned to the initiator associated with the STP initiator bridge 202 and a target address of an STP storage bridge 206 may be associated with the initiator. A storage device, such as the storage device 116, connected to the STP storage bridge 206 may be a shared storage resource of server nodes, such as the server nodes 114 of FIG. 1. Next, in block 406, expander device 107 may configure the STP storage bridge 206. For example, expander device 107 may set storage slice parameters and create a SAS address lookup table in the STP storage bridge. Further, expander device 107 may set initial time share parameters for each of the initiators in the STP storage bridge.

In one example, disclosed is an expander device that provides for SATA initiator addressing and storage device slicing, and that is configured to inject an additional pseudo SATA initiator in the form of a diagnostic request directed at a storage device. For example, in some embodiments, an expander device configures an initiator SAS address to uniquely identify a SATA initiator, where the SATA initiator is associated with a target address of a STP storage bridge. The STP storage bridge may be configured to associate the initiator SAS address with a drive slice of a SATA storage device, and there can be one or more drive slices, which can be sliced over a time domain or based on capacity. In this manner, example embodiments disclosed herein allow multiple SATA initiators to share a single SATA storage device. Specifically, by assigning an initiator SAS address to a SATA initiator, the SATA requests may be intercepted by an expander and routed to an appropriate drive slice of the shared SATA storage device. Because the routing is abstracted by the expander, the SATA initiator and SATA storage device may operate in a conventional fashion without any knowledge of the initiator SAS address assignment. A diagnostics request made from a chassis manager is injected by the expander device as a pseudo SATA initiator, and communicates with a drive or drive slice in the same manner as other initiators of the current method and system.

In block 408, expander device 107 may process a SATA request from a current initiator. The current initiator may be the initiator that currently has priority with the STP storage bridge because the current initiator's time share is active. The current initiator can include, in some cases, the pseudo SATA initiator that is embodied by a diagnostics request originating at a chassis manager 118. In some examples, SATA requests may be processed with respect to drive capacity slicing techniques. In some examples, an entire drive could be processed as a single slice. In other examples, if a SATA request from an initiator includes an inquiry command for storage parameters, the SATA request may be processed by the STP storage bridge by returning storage parameters that describe a drive slice associated with the initiator as if the drive slice were a distinct storage device. In other words, the initiator is unaware that it is accessing a partition of a shared storage device. Storage parameters provided by the STP storage bridge may include a storage device type (e.g., magnetic disk, magnetic tape, optical drive device, etc.), a size of the drive slice, support for various addressing modes, a human-readable description of the drive slice, etc.

At decision node 410, it is determined if the time share of the current initiator is complete. If the time share is not complete, method 400 returns to block 408, where expander device 107 continues to process SATA requests from the current initiator. Continuing to decision node 412, a determination is made whether the diagnostics or health request has been initiated by a chassis manager. If it is determined that the chassis manager has initiated a diagnostics request, then method 400 continues to process the diagnostics or health request at block 414. As an example of how the chassis manager can essentially communicate directly with a storage device, an Ethernet connection is made from the chassis manager to a satellite controller, which is a conduit to connect with the expander device via an I²C bus. In this way, the chassis manager can be configured to access a storage device, and the request can act as a pseudo initiator to be injected to a storage device under a time domain. In one example, disclosed herein, a host SATA controller is not accessed when the chassis manager initiates the diagnostics request.

After the health request is processed at block 414, or if it was determined at decision node 412 that no health request had been initiated after the time share was complete, then a determination is made at node 416 whether time share adjustments should be made. The determination may be made based on the performance requirements of the initiators, which may be calculated by measuring runtime (i.e., during operation of expander device 107) performance metrics of each initiator. Performance metrics may include, for example, the number of command timeouts (i.e., time shares with no command activity) and the number of commands during each time share of an initiator. An initiator that has a large number of command timeouts during its time shares may be a candidate for having its time share reduced. Conversely, an initiator that has a large number of commands during its time shares may be a candidate for having its time share increased.

If it is determined at node 416 that a time share adjustment should be made, the time share parameters for the initiators may be adjusted at block 418. For example, an initiator with a large number of commands during its time share may receive an increased time share while an initiator with a large number of command timeouts during its time shares may receive a decreased time share. If it is determined that a time share adjustment should not be made, the current initiator may be set to the next initiator with a time share at block 420. At this stage, method 400 may return to block 408, where the expander device may process SATA requests from the next initiator.

The method of FIG. 4 is not intended to indicate that method 400 is to include all of the steps shown in FIG. 4. Further, any number of additional steps may be included within the method 400, depending on the details of the specific implementation.

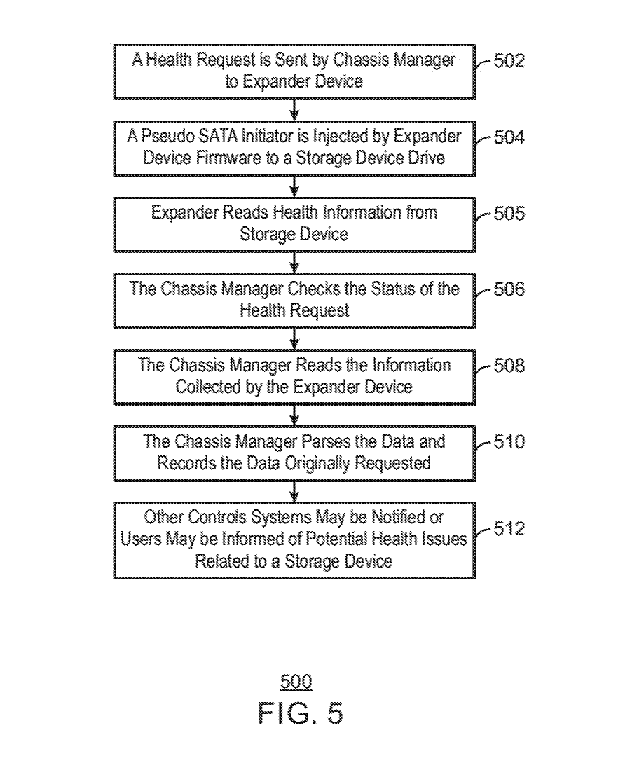

FIG. 5 is a flowchart of an example method for execution by an expander that receives a health request from chassis manager and obtains diagnostics information from a SATA storage device. Method 500 begins at block 502 when a diagnostics request, such as a request for health information, is sent by a chassis manager to an expander device. A diagnostics request can include, for example, a temperature indication request, overall health indication request, or a power indication request of the storage device 116. These diagnostics indications can be helpful for network system users, and the data can ultimately be stored at a central location, such as at the chassis manager. In some embodiments, reading the temperature of the storage devices enables the chassis manager to control the fans properly to maintain the thermal requirements. This also enables the chassis manager to report the overall health of the storage devices from a central location. Method 500 continues at block 504 where a pseudo SATA initiator is injected by firmware of the expander device to a storage device drive. No physical initiator is injected at block 504. Only a request for diagnostics information, which appears to the system as any other initiator trying to establish communication with the storage device, is “injected” by the expander device.

At block 505, the expander device reads the health information from the storage device. Method 500 continues when the chassis manager checks the status of the diagnostics or health request at block 506. If the expander has received the information related to the request, then the chassis manager will obtain that information. If the expander has not yet received all the pertinent data related to the diagnostics request, then the chassis manager may be configured to wait, and periodically check the status of the request at the expander until the data are ready to be relayed. When the health request is complete, at block 508, the chassis manager reads the information collected by the expander device based on the health request. At block 510, the chassis manager is configured to parse the data, and can record the data originally requested at block 502.

In one example, the chassis manager is configured to communicate directly with a storage device through a satellite controller/conduit, and through the pseudo SATA initiator injected by the expander device. This provides a way for the chassis manager to essentially have direct access to a storage device independent of the servers. In an example, the chassis manager is configured to access the health, temperature, and other information related to a storage device, regardless of whether the server nodes are in fault condition or are powered down.

Method 500 can optionally continue to block 512, where other controls systems may be notified or users may be informed of potential health issues related to a particular storage device. Drive information about the storage device can be received from the storage device itself, enabling the chassis manager to determine information like drive temperature and whether the drive is in a fail state or powered off. Controls systems can be configured to use the information stored at the chassis manager to send signals to a particular storage device or server node. Control of the storage device, such as control of drive fan speed, and control of power to the drive, for example, can be achieved.

The method of FIG. 5 is not intended to indicate that method 500 is to include all of the steps shown in FIG. 5. Further, any number of additional steps may be included within the method 500, depending on the details of the specific implementation.

FIG. 6 is a block diagram showing an example non-transitory, computer-readable medium that stores instructions for providing SATA initiator addressing, storage device slicing, and injecting a health request. The non-transitory, computer-readable medium is generally referred to by the reference number 600 and may be included in the expander device described in relation to FIGS. 1 and 2. The non-transitory, computer-readable medium 600 may correspond to any typical storage device that stores computer-implemented instructions, such as programming code or the like. For example, the non-transitory, computer-readable medium 600 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, solid state drives and flash memory devices.

A processor 602 generally retrieves and executes the instructions stored in the non-transitory, computer-readable medium 600 to operate the storage device in accordance with an example. In an example, the tangible, machine-readable medium 600 can be accessed by the processor 602 over a bus 604.

A region 606 of the non-transitory, computer-readable medium 600 may include functionality to implement an expander device as described herein. For example, the instructions may include instructions for receiving a request for diagnostics of components of the storage cartridge. The instructions may also include instructions for inserting the request for diagnostics at a time slice by an expander of the storage cartridge; wherein the request is inserted into a time slice of a serially attached small computer system protocol data stream.

Although shown as contiguous blocks, the software components can be stored in any order or configuration. For example, if the non-transitory, computer-readable medium 600 is a hard drive, the software components can be stored in non-contiguous, or even overlapping, sectors.

The foregoing disclosure describes a number of example embodiments for providing SATA initiator addressing and storage device slicing, and describes using a pseudo SATA initiator in the form of a diagnostics request. In this manner, the embodiments disclosed herein encapsulate SATA initiator addressing in an expander device that routes SATA requests from multiple initiators to drive slices of a single target device. Appearing to the system as another of the SATA initiators is a pseudo SATA initiator, which is not an actual initiator, but is merely a request for information that originates at a chassis manager, is processed at the expander device, and is injected when ready in a similar manner as another initiator. Thus, the expander device is configured to provide SATA initiator addressing and storage device slicing, while injecting a pseudo SATA initiator and without using an actual SATA host controller to facilitate communication with the drive slice.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method, comprising:
configuring an expander device of a storage cartridge to partition a time slice of a serially attached small computer system protocol data stream; and
receiving a request for diagnostic information of components of the storage cartridge from a chassis manager; and
injecting a serial advanced technology attachment (SATA) initiator in a time slice in response to receiving the request from the chassis manager.

2. The method of claim 1, further comprising providing diagnostic information about a SATA storage device to the chassis manager without use of a SATA controller to handle the diagnostic request from the chassis manager.

3. The method of claim 1, further comprising:
checking the status of the request for diagnostic information at the chassis manager; and
reading the diagnostic information collected by the expander device.

4. The method of claim 3, further comprising recording the diagnostic information collected by the expander device at the chassis manager.

5. The method of claim 3, further comprising controlling a variable of the storage cartridge that is configured to be controlled, based on the diagnostic information collected.

6. The method of claim 1, wherein the SATA initiator is a pseudo SATA initiator sent from the chassis manager in comparison to an initiator provided from server nodes in a network, and wherein the expander device is configured to inject the pseudo SATA initiator at the target drive.

7. An expander device at least partially comprising logic configured to:
receive a request for diagnostics of components of a storage cartridge;
insert the request for diagnostics at a time slice of a serially attached small computer system protocol data stream, the insertion provided by an expander of the storage cartridge as a result of receiving the request from a chassis manager as opposed to an initiator associated with hardware components of a server node communicatively coupled to the storage cartridge.

8. The expander device of claim 7, further comprising:
an initiator management module to configure an initiator serial attached small computer system interface (SAS) address to identify a serial advanced technology attachment (SATA) initiator;
a serial tunneled protocol (STP) server bridge to:
receive a SATA request from the SATA initiator; and
send, after inserting the initiator SAS address into the SATA request, a STP connection request to the target address; and
a storage management module configured to receive commands from the chassis manager, and to configure a STP storage bridge to associate the initiator SAS address with a SATA storage device.

9. The expander device of claim 8, wherein the expander device is configured to communicate directly with the chassis manager, wherein the chassis manager is configured to send the request for diagnostics.

10. The expander device of claim 9, wherein the request for diagnostics is processed by the expander device, and diagnostics information are configured to be sent to the chassis manager.

11. The expander device of claim 8, wherein the storage management module configures the STP storage bridge to provide a predetermined time share for the SATA initiator.

12. A non-transitory, computer-readable medium encoded with instructions executable by a processor, the machine-readable storage medium comprising:
instructions for receiving a request for diagnostics of components of a storage cartridge; and
instructions for inserting the request for diagnostics at a time slice by an expander of the storage cartridge; wherein the request is inserted into a time slice of a serially attached small computer system protocol data stream.

13. The computer-readable medium of claim 12, further comprising:
instructions for configuring a serial tunneled protocol (STP) storage bridge to provide a time share for a serial advanced technology attachment (SATA) initiator;
instructions for receiving a SATA request from the SATA initiator;
instructions for detecting runtime performance requirements of the SATA initiator;
instructions for modifying the time share based on the runtime performance requirements to obtain a modified time share; and
instructions for providing diagnostics information about a SATA storage device.

14. The computer-readable medium of claim 13, wherein the SATA initiator is a pseudo SATA initiator in the form of the request for diagnostics of components of the storage cartridge in comparison from an initiator of a server node communicatively coupled to the storage cartridge.

15. The computer-readable medium of claim 12, further comprising instructions for communicating requested diagnostic information to a centralized chassis manager for further storage and analysis.
